(19) United States
(12) Patent Application Publication
(10) Pub. No.: US 2009/0270048 A1
(43) Pub. Date: Oct. 29, 2009

(54) METHOD AND SERVER FOR ESTABLISHING A COMMUNICATION LINK BETWEEN COMMUNICATION TERMINALS IN A PRESELECTED GROUP

(75) Inventor: Thomas Wolff, Berlin (DE)

Correspondence Address: LERNER GREENBERG STEMER LLP, P O BOX 2480, HOLLYWOOD, FL, 33022-2480, US

(73) Assignee: Nokia Siemens Networks GmbH & Co. KG

(21) Appl. No.: 12/160,687

(22) PCT Filed: Dec. 15, 2006
(86) PCT No.: PCT/EP06/69783

§ 371 Date: Jul. 20, 2009

(30) Foreign Application Priority Data
Jan. 12, 2006 (DE) 10 2006 002 434.6

(51) Int. Cl. H04B 1/38

(52) U.S. Cl. 455/90.2

(57) ABSTRACT

The invention relates to a method for establishing a communication link between communication terminals (KEB1, KEG2, KEG3) which are associated with a preselected group (G) of communication terminals. According to said method, a start message 1 is captured by a server (S1, S2) of a communication link (KN1, KN2), which is sent by the communication terminal (KEG3), the preselected group is determined by the server using information transferred in the start message via the communication terminal (KEG3) and is associated with the communication terminal (KEG3). Also, a link message (2) is transferred by the server (S1, S2) to the communication terminal (KEG3). The server (S1, S2) captures a link confirmation message (3) which is sent by the communication terminal, whereby the communication link between the communication terminal (KEG3) and additional communication-ready communication terminals (KEG1, KEG2) of the group, is produced. The invention also relates to a server.

### CLAIM FOR PRIORITY

This application is a national stage application of PCT/EP2006/069783, filed Dec. 15, 2006, which claims the benefit of priority to German Application No. 10 2006 002 434.6, filed Jan. 12, 2006, the contents of which hereby incorporated by reference.

### TECHNICAL FIELD OF THE INVENTION

The invention relates to a method and server for establishing a communication link between communication terminals which belong to a preselected group of communication terminals.

### BACKGROUND OF THE INVENTION

In modern communication networks, services are increasingly offered in which not only two communication terminals communicate with one another—as e.g. in traditional telephony—but in which more than two communication terminals communicate with one another. In such services, a communication link is established between (generally) a number of communication terminals which form a group of communication terminals or belong to a group of communication terminals. Examples of such group communication services are the so-called push-to-talk service in which a communication terminal can in each case send voice messages simultaneously to a number of other communication terminals of the group. Another example is the so-called chat service in which a communication terminal of the group can simultaneously send text messages to the other communication terminals of the group. To establish the communication link, needed for such group communication services, between the communication terminals of the group, it is conceivable that a communication terminal of the group takes over a special function: the function of a response entity in the group (so-called originator). The user of this special communication terminal would then have to ensure that the communication link to the respective other communication terminals of the group is established. However, such a method would be complex and uncomfortable for the user of this communication terminal.

### SUMMARY OF THE INVENTION

The invention relates to a method and a device for establishing a communication link between communication terminals of a group in a simple and comfortable manner.

According to one embodiment of the invention, there is a method for establishing a communication link between communication terminals which belong to a preselected group of communication terminals, wherein, in the method, a server of a communication network receives a start message which was sent by a communication terminal, the server determines by means of information about the communication terminal, transmitted in the start message, the preselected group to which the communication terminal belongs, and the server transmits a link message to the communication terminal and the server receives a link confirmation message sent thereupon by the communication terminal, as a result of which the communication link between the communication terminal and other communication terminals of the group which are ready for communication is established. In this context, it is particularly advantageous that none of the communication terminals of the group needs to take over the function of the originator. Instead, a server of the communication network advantageously receives the start message sent by the communication terminal, determines the preselected group, transmits the link message to the communication terminal and receives the link confirmation message sent by the communication terminal. This establishes the communication link between the communication terminal and the other communication terminals of the group which are ready for communication. In this context, the communication terminal advantageously only needs to send the start message to the server. The other method steps then take place automatically and essentially without assistance by the communication terminal. This method does not require any communication terminals with an originator function.

In one aspect of the invention, the server receives the start message which was sent by the communication terminal after its switch-on or after activation of a communication function of the communication terminal. In this context, the start message can be sent preferably automatically to the server by the communication terminal immediately after its switch-on. The result is that immediately after the communication terminal has been switched on, the method steps for establishing the communication link are executed and the communication terminal can communicate with the other communication terminals of the group without significant delays. As an alternative, the start message can also be sent after an activation of a communication function at the communication terminal. In this case, the communication terminal can be operated preferably in two different modes: when the communication function is not activated, no communication link is established with the other communication terminals of the group and the communication terminal can be used in the conventional manner (for example for traditional telephone calls between a calling communication terminal and a called communication terminal); whereas the communication link is established to the other communication terminals of the group when the communication function is activated.

The communication link can be preferably established in order to implement a group communication service, particularly a push-to-talk service or a chat service.

In another aspect of the invention, the server simulates an additional communication terminal of the group which, by means of the link message, initiates the establishing of the communication link between the communication terminal and the other communication terminals of the group which are ready for communication. This variant of an embodiment of the method according to the invention has the advantage that it does not contravene standards, i.e. the method can be used with standard-compliant group communication services.

In another aspect of the invention, the method can proceed such that as the start message, a message is used by means of which the communication terminal registers in the communication network for using Internet protocol-based services. This variant of an embodiment has the advantage that no additional start message is needed for the method according to the invention but that a message already utilized in communication networks, by means of which the communication terminal registers for the utilization of Internet protocol-based services, is used additionally as start message.

The session initiation protocol message “REGISTER”, known as such, can be used preferably as such a start message.

The session initiation protocol message “INVITE”, known as such, can be used advantageously as link message.

In another embodiment of the invention, there is a server for a communication network which is designed for receiving a start message which was sent by a communication terminal, for determining a preselected group of communication terminals, to which the communication terminal belongs, by means of information about the communication terminal transmitted in the start message, and for transmitting a link message to the communication terminal and for receiving a link confirmation message, sent thereupon by the communication terminal, by means of which the communication link between the communication terminal and other communication terminals of the group which are ready for communication is established. By means of this server, the communication link between the communication terminal and the other communication terminals of the group which are ready for communication can be advantageously automatically established in a simple and comfortable manner for the user of the communication terminal after reception of the start message.

In one aspect of the invention, the server can have a user interface for changing the group membership of communication terminals. The association of the communication terminals with the group can thus be advantageously changed, i.e. the group can be administered.

In another aspect of the invention, the server can be designed for implementing a group communication service, particularly a push-to-talk service or a chat service.

In still another aspect of the invention, the server can be designed in such a manner that it simulates an additional communication terminal of the group which, by means of the link message, initiates the establishing of the communication link between the communication terminal and the other communication terminals of the group which are ready for communication. This makes it advantageously possible to use this server in standard-compliant push-to-talk-over-cellular services.

In yet another aspect of the invention, the server can also be designed for receiving a start message by means of which the communication terminal registers in the communication network for using Internet protocol-based services. As a result, the server can advantageously receive the message sent in any case for the purpose of registration by the communication terminal so that no additional message needs to be sent by the communication terminal.

The server can be preferably designed for receiving a start message in the form of the session initiation protocol message “REGISTER”. This enables the “REGISTER” message, known as such, to be used as start message.

Furthermore, the server can be advantageously designed for transmitting a link message in the form of the session initiation protocol message “INVITE”.

### BRIEF DESCRIPTION OF THE DRAWINGS

In the text which follows, the invention will be explained in greater detail with reference to exemplary embodiments, for which

FIG. 1 shows a first exemplary embodiment of a communication network with a group of communication terminals.

FIG. 2 shows a second exemplary embodiment of a communication network with a group of communication terminals.

FIG. 3 shows an exemplary sequence of the method by means of a message flowchart.

### DETAILED DESCRIPTION OF THE INVENTION

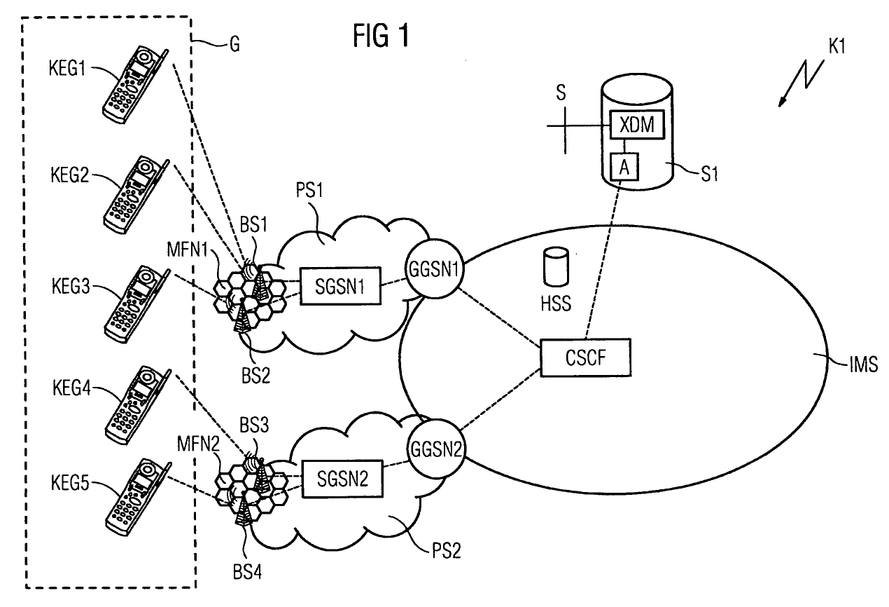

FIG. 1 shows a first communication network K1 which comprises a first mobile radio network MFN1, a first packet-switched domain PS1, an Internet protocol-based multimedia subsystem IMS, a server S1 in the form of a push-to-talk server, a second packet-switched domain PS2 and a second mobile radio network MFN2. In the first mobile radio network MFN1, a first base station BS1 and a second base station BS2 are arranged which is connected to a first switching center SGSN1 (serving GPRS support node) of the first packet-switched domain PS1. The first switching center SGSN1 is connected via a first gateway GGSN1 (gateway GPRS support node) to a control unit CSCF (call state control function) of the Internet protocol-based multimedia subsystem. In the multimedia subsystem IMS, a home subscriber server HSS is also located. The control unit CSCF is connected to the server S1. The server S1 contains a computer program A (application) for controlling the method steps of the method described. The server also has a database XDM (data memory) which can be accessed via a user interface (administration interface) S.

The control unit CSCF is also connected via a second gateway GGSN2 to a second switching center SGSN2 of the second packet-switched domain PS2. The second switching center SGSN2, in turn, is connected to a third base station BS3 and a fourth base station BS4 of the second mobile radio network MFN2.

Five communication terminals KEG1, KEG2, KEG3, KEG4 and KEG5 can be connected to the communication network K1 via the base stations BS1 to BS4. The communication terminals KEG1 to KEG5 are GPRS-enabled (general packet radio service) mobile telephones in the exemplary embodiment. In other exemplary embodiments, however, communication terminals in the form of, for example, a portable computer with mobile radio interface, a palmtop, a landline telephone or a personal computer can also be used. The five communication terminals KEG1 to KEG5 belong to a preselected group G of communication terminals. This group membership is symbolized by a dashed border.

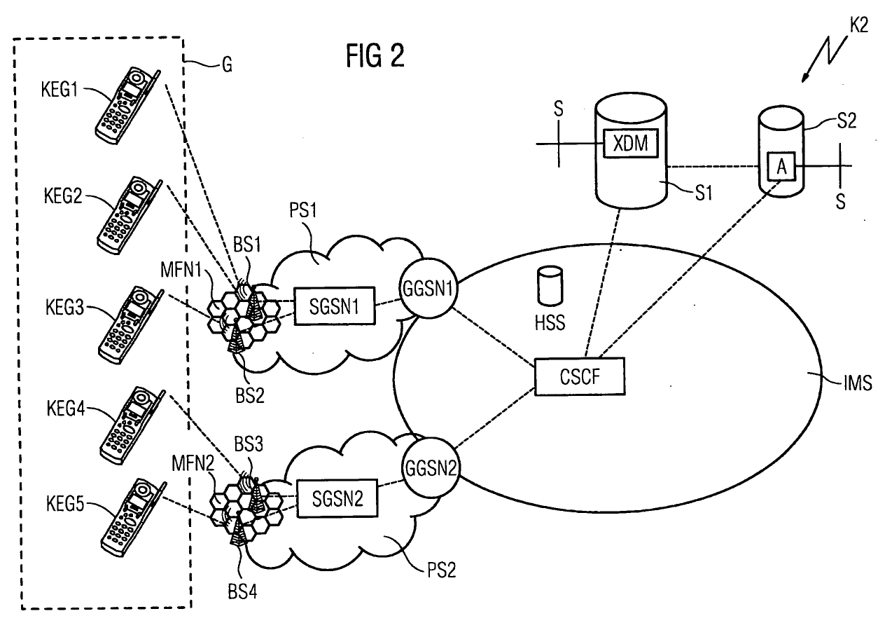

FIG. 2 shows a second communication network K2 which differs from the first communication network K1, described in conjunction with FIG. 1, essentially only in that the control unit CSCF is connected not only to the push-to-talk server S1 but additionally to a second server S2 in the form of a session initiation protocol application server S2 (SIP application server). In the second communication network K2, the program A is not arranged in the push-to-talk server S1 but in the SIP application server S2. In the second communication network K2 shown in FIG. 2, the method steps are controlled by the program A running in the SIP application server S2. This program A can access the database XDM arranged in the push-to-talk server S1 and controls the (elementary) communication functions of the server S1 (e.g. the push-to-talk functions via SIP), especially in order to initiate the INVITE link message and establish the communication link of all communication terminals ready for communication which belong to the same preselected communication group. As an alternative, the database XDM can also be arranged in the server S2.

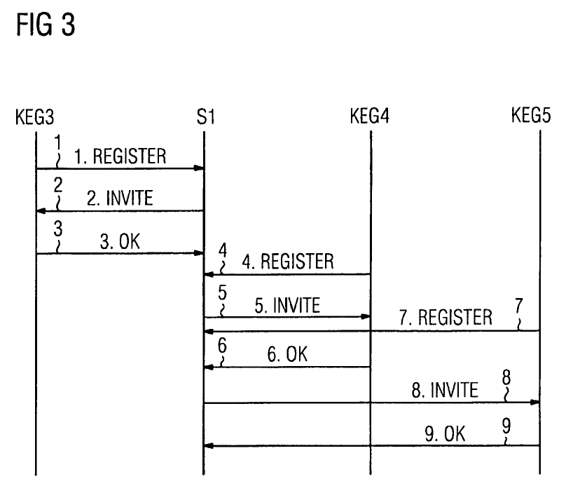

FIG. 3 shows a message sequence of the method according to the invention. In the text which follows, an exemplary sequence of the method according to the invention and the operation of the server according to the invention are explained by means of FIGS. 3 and 1. This is based on the assumption of the following initial situation: a communication link has already been established between the communication terminals KEG1 and KEG2; via this communication link, a push-to-talk service is implemented in which communication terminals KEG1 and KEG2 participate. The communication terminals KEG1 and KEG2 participate in a push-to-talk session of the group G. The push-to-talk service is also called “group talk”. The push-to-talk (PTT) service is implemented here via the packet-switched Internet protocol-based multimedia subsystem; in this connection, this service is also called “push-to-talk-over-cellular” (PoC). A session of a group communication service is generally also called “session”.

A user of the communication terminal KEG3 would also like to participate in the push-to-talk service and therefore switches on his communication terminal KEG3. Immediately following the switching-on of the communication terminal KEG3, the communication terminal KEG3 sends a first start message 1 in the form of an SIP message “REGISTER” to the first communication network K1 (arrow 1: REGISTER). This first start message 1 passes via the second base station BS2, the first switching center SGSN1, the first gateway GGSN1 to the control unit CSCF of the multimedia subsystem IMS. By means of this start message “REGISTER”, the third communication terminal KEG3 is logged in in familiar manner at the multimedia subsystem IMS; it is registered in the Internet multimedia subsystem that the communication terminal KEG3 is ready for communication (“online”). By means of this start message 1, the communication terminal KEG3 thus registers itself for utilization of Internet protocol-based services offered by the communication network K1. Following this, the start message 1 is forwarded to the push-to-talk server S1 and reaches the program A running in it. (In the exemplary embodiment described further below by means of FIG. 2, the start message 1 is forwarded to the server S2 and reaches the program A running in it.)

In another method sequence, the start message can also be sent by the communication terminal KEG3 only after a communication function has been activated on the communication terminal KEG3 (for example by its user); this activation could take place, for example, by the user operating a particular key on the communication terminal KEG3.

After the reception of the start message 1 at the server end, the server (more precisely the program A running in the server) reads out an information item contained in the start message and transmitted with the start message about the communication terminal KEG3. This information item about the communication terminal can be present, for example, as a telephone number (MSISDN—mobile station ISDN number) or as a session initiation protocol address (e.g. user@domain.com). In precise terms, this information about the communication terminal describes the user of the communication terminal KEG3. However, since the user of the communication terminal KEG3 remains unchanged during the entire method sequence and has “personalized” the communication terminal KEG3 as it were (for example by plugging a personal SIM card into the terminal (subscriber identity module)), this telephone number or this SIP address represents information about the terminal KEG3 during the method sequence. The term “information about the communication terminal” is used in this sense in this description. Using this information about the communication terminal, the server S1 determines the preselected group to which the communication terminal belongs. Information about the group membership of the individual communication terminals is stored in the database XDM in the server S1 (or in a database provided especially for this purpose). In the exemplary embodiment, the server S1 contains stored such group information that the communication terminal KEG3 belongs to the group G and that communication terminals KEG1, KEG2, KEG4 and KEG5 also belong to group G. (In the exemplary embodiment described further below by means of FIG. 2, the information about the group membership of the individual communication terminals can be stored in the server S1 or also in the server S2 in the database XDM or in a database provided especially for this purpose.)

After evaluation of the group information, the server S1 thus has the information that the communication terminal KEG3 belongs to group G. The server S1 thereupon sends a link message 2 in the form of the session initiation protocol message “INVITE”, known as such, to the communication terminal KEG3. This link message 2 is transmitted from the server S1 via the control unit CSCF, the first gateway GGSN1, the first switching center SGSN1 and the base station BS2 to the communication terminal KEG3. The communication terminal KEG3 thereupon sends a link confirmation message 3 in the form of a session initiation protocol message “OK” to the server S1. This link confirmation message 3 is conveyed from the communication terminal KEG3 via the second base station BS2, the first switching center SGSN1, the first gateway GGSN1 and the control unit CSCF to the first server S1. The server S1 receives this link confirmation message 3. With the reception of the link confirmation message 3, the communication link between the communication terminal KEG3 and the communication terminals KEG1 and KEG2 already participating in the push-to-talk service in group G is established by the push-to-talk server S1. By means of an information item about the session, contained in the link message 2 and the link confirmation message 3, e.g. by means of a name contained in the form of an SIP address, the server S1 allocates the communication terminal KEG3 to this session and then also transmits the voice messages from and to the communication terminal KEG3. A communication link thus now exists between the communication terminals KEG1, KEG2 and KEG3; these three communication terminals can now communicate with one another as part of the push-to-talk service, this communication being handled via the push-to-talk server S1.

In this method, the server S1, in the establishment of the communication link (during the link set-up), simulates an additional communication terminal of group G, a virtual sixth communication terminal, as it were. This is because the server S1 acts like a communication terminal, like a so-called “SIP user agent” of an SIP-enabled mobile telephone in the exemplary embodiment. This is because, from the point of view of the communication terminal KEG3, the link message 2 appears to originate from an additional communication terminal, where this additional communication terminal handles the function of an originator. The communication terminal KEG3 can thus not see that it is not communicating with a communication terminal but with the server S1. This is particularly advantageous because, as a result, the method described does not contravene the “OMA PoC Control Plane, Candidate Version 1.0-4 Nov 2005, Open Mobile Alliance, OMA-TS-PoC-ControlPlane-V1_{—}0-20051104-C” standard: the communication terminal KEG3 and furthermore also the communication terminals KEG4 and KEG5 do not recognize that they are communicating with a server (and not with a communication terminal) during the establishment of the communication link. Thus, the communication terminals KEG3, KEG4 and KEG5 do not need to be modified or adapted for use in the method according to the invention.

he method described can also be used for implementing another group communication service, for example a chat service. Instead of the push-to-talk server S1, a chat server would then be equipped with the program A, this chat server implementing the chat service. The sequences for establishing the communication link between the communication terminals of the group, described above, would proceed in the same manner in this arrangement. The chat service is occasionally also called “chat group talk”. Next, a user of the communication terminal KEG4, by operating a corresponding key, activates the push-to-talk communication function of his communication terminal KEG4. The communication terminal KEG4 thereupon sends a second start message 4 (arrow 4: REGISTER) to the server S1. The server S1 receives this second start message 4, determines, by means of an information item about the terminal KEG4 transmitted in the start message (for example by means of the SIP address Meier@yxz.com), by utilizing the database XDM, that the communication terminal KEG4 belongs to group G. The server S1 thereupon sends a second link message 5 (arrow 5: INVITE) to the communication terminal KEG4. The communication terminal KEG4 answers with a second link confirmation message 6 (arrow 6: OK) which is received by the server S1. The server S1 thereupon establishes the communication link between the communication terminal KEG4 and the communication terminals KEG1, KEG2 and KEG3, already using the push-to-talk service, in the manner described above. The push-to-talk service can now proceed between the four communication terminals KEG1 to KEG4; each of these communication terminals can send voice messages to the other three communication terminals via the communication link and receive voice messages from these.

During the sequence of the method steps for establishing the communication link between the communication terminal KEG4 and the communication terminals KEG1, KEG2 and KEG3, a user of communication terminal KEG5 has already switched on his communication terminal and activated the communication function. The communication terminal KEG5 thereupon sends a third start message 7 (arrow 7: REGISTER) to the server S1. The server S1 receives this third start message 7, reads the transmitted information about the terminal out of the third start message and, by means of this transmitted information (e.g. an SIP address), determines that the communication terminal KEG5 also belongs to group G. The server S1 thereupon sends a third link message 8 (arrow 8: INVITE) to the communication terminal KEG5. The communication terminal KEG5 answers with a third link confirmation message 9 (arrow 9: OK). The communication link between the communication terminal KEG5 and the communication terminals KEG1 to KEG4 of group G is thereupon established. The push-to-talk server S1 implements the push-to-talk service, i.e. the push-to-talk server transmits, e.g. voice message packets between the communication terminals of the group.

The group membership of the communication terminals can be altered via the user interface S of server S1 (i.e. group G can be administered or configured, respectively). It is possible to access the database XDM of the push-to-talk server S1 directly via this user interface (administration interface) S; such a database is also called “push-to-talk-over-cellular XML (extended markup language) document management (PoC XDM). This user interface can be accessed in various ways. An access can be made, for example, by a communication terminal (for example communication terminal KEG3) by using the XCAP (XML Configuration Access Protocol) protocol. However, the user interface S can also be accessed by a network operator of the communication network K1 or from a call center, where a user can use a so-called customer care portal for changing the group membership of his communication terminal. Finally, it is also possible that a user of the communication terminals (for example a user of communication terminal KEG3) accesses the database XDM of the push-to-talk-over-cellular service via a computer connected to the Internet, using an Internet page/a web interface via the user interface S of the server S1. The last-mentioned possibility of changing/administering the group membership of the communication terminal advantageously enables the group membership to be administered and to change in a particularly comfortable manner via an Internet page.

The method described above can also be performed in the same manner with the communication network K2 of FIG. 2, with the difference that the program A runs in the server S2 and the server S2 works in conjunction with the database arranged in the server S1. Server S1 then also receives or sends the start messages, link messages and link confirmation messages and communicates with the server S2. As an alternative, the start messages, the link messages and the link confirmation messages can be transmitted from the control unit CSCF via the server S1 to the server S2, and conversely, or the start messages can be transmitted directly from the control unit CSCF to the server S2.

The method described for establishing a communication link between communication terminals of a group is essentially controlled by the server. This method has a number of advantages:

The preselected or preconfigured group (priority group) is persistent (permanent, non-volatile), i.e. if one of the mobile communication terminals of the group is replaced by another device (for example in the case of a defect or loss of a communication terminal), the preselected group does not need to be newly administered because the group database (PoC XDM) in the server is not changed by exchanging a mobile communication terminal. This is of advantage, especially if communication terminals are handed on by a user to another user and are newly personalized, for example by inserting a new SIM card. In this case, too, no change of the database arranged in the server is necessary.

The method can proceed with any communication terminals as long as they are suitable for the group communication service (that is to say, for example, the push-to-talk service or the chat service). In the communication terminals, no special functions relating to the method are needed; these special functions are implemented in the server, instead. This is a considerable advantage both for the vendors of communication terminals, for network operators of communication networks and for service providers. This advantage becomes particularly clear if one recalls that it is often very difficult to produce suitable terminals in sufficient number, and to make them available to the service user, for newly developed innovative communication technologies or services.

The server behaves like a communication terminal so that the method can be implemented without infringing on standards; the method can also be implemented easily in communication networks already in existence.

The SIP message “REGISTER” is advantageously used not only for registering the communication terminal in the communication network but is used at the same time also as start message. This message is received by the server and starts the method sequence, for example, the start message activates the program A contained in the server S1 which controls the further method sequence (the start message triggers the program).

The program A can be stored advantageously either in the push-to-talk server S1 and run there or the program A can be stored in a server connected to the push-to-talk server (e.g. an SIP application server), and run there. This results in a method which can be variably adapted to the situations present in each case in the communication networks.

1. A method for establishing a communication link between communication terminals which belong to a preselected group of communication terminals, comprising:
receiving, at a server of a communication network, a start message which was sent by a communication terminal;
determining, at the server, using information about the communication terminal, transmitted in the start message, the preselected group to which the communication terminal belongs;
transmitting, from the server, a link message to the communication terminal and receiving, at the server, a link confirmation message sent by the communication terminal; and
establishing the communication link between the communication terminal and other communication terminals of the group which are ready for communication.

2. The method as claimed in claim 1, wherein
the server receives the start message which was sent by the communication terminal after its switch-on or after activation of a communication function of the communication terminal.

3. The method as claimed in claim 1, wherein
the communication link is established to implement a group communication service.

4. The method as claimed in claim 1, wherein
the server simulates an additional communication terminal of the group which, via the link message, initiates establishment of the communication link between the communication terminal and the other communication terminals of the group which are ready for communication.

5. The method as claimed in claim 1, wherein
as the start message is used such that the communication terminal registers in the communication network for using Internet protocol-based services.

6. The method as claimed in claim 1, wherein
the session initiation protocol message “Register” is used as the start message.

7. The method as claimed in claim 1, wherein
the session initiation protocol message “Invite” is used as link message.

8. A server for a communication network wherein the server:
receives a start message sent by a communication terminal;
determines a preselected group of communication terminals, to which the communication terminal belongs, using information about the communication terminal transmitted in the start message; and
transmits a link message to the communication terminal and receives a link confirmation message, sent by the communication terminal, such that the communication link between the communication terminal and other communication terminals of the group which are ready for communication is established.

9. The server as claimed in claim 8,
comprising a user interface for changing group membership of communication terminals.

10. The server as claimed in claim 8, wherein
the server implements a group communication service.

11. The server as claimed in claim 8, wherein
the server simulates an additional communication terminal of the group which, using the link message, initiates establishment of the communication link between the communication terminal and the other communication terminals of the group which are ready for communication.

12. The server as claimed in claim 8, wherein
the server receives the start message such that the communication terminal registers in the communication network for using Internet protocol-based services.

13. The server as claimed in claim 8, wherein
the server receives start message in the form of session initiation protocol message “Register”.

14. The server as claimed in claim 8, wherein
the server transmits a link message in the form of session initiation protocol message “Invite”.
